(19) United States
(12) Patent Application Publication
(10) Pub. No.: US 2017/0055078 A1
(43) Pub. Date: Feb. 23, 2017

(54) IN-CAR COMMUNICATION

(71) Applicant: Harman Becker Automotive Systems GmbH, Karlsbad (DE)

(72) Inventor: Markus CHRISTOPH, Straubing (DE)

(21) Appl. No.: 15/236,089

(22) Filed: Aug. 12, 2016

(30) Foreign Application Priority Data
Aug. 20, 2015 (EP) 15181678.2

(51) Int. Cl. H04R 3/12; H04R 1/02; H04R 3/00; H04R 1/32

(52) U.S. Cl. CPC H04R 3/12; H04R 1/323; H04R 1/025; H04R 3/005; H04R 2499/13

(57) ABSTRACT

An in-car communication system and method configured to pick up sound from the first passenger position with a first microphone arrangement in the vicinity of a first passenger position and to convert the picked-up sound into a first electrical microphone signal. The system and method are further configured to convert with a first loudspeaker arrangement in the vicinity of a second passenger position a first electrical loudspeaker signal into sound, to radiate the sound to the second passenger position, and to process the first electrical microphone signal to provide the first electrical loudspeaker signal. The first loudspeaker arrangement has a principal transmitting direction into which it radiates its maximum sound energy. The loudspeaker arrangement is disposed such that the radiated maximum sound energy is concentrated at the second passenger position.

### CROSS-REFERENCE TO RELATED APPLICATIONS

This application claims priority to EP application Serial No. 15181678.2 filed Aug. 20, 2015, the disclosure of which is hereby incorporated in its entirety by reference herein.

### TECHNICAL FIELD

The disclosure relates to a system and method (generally referred to as a “system”) for communication in a room, particular in the interior of a vehicle.

### BACKGROUND

Due to a large amount of background noise, the communication within a vehicle, such as a car, driving at high or even moderate speed is often difficult. This is especially true if one of the communication partners is the driver and the other is one of the backseat passengers. As a result of the high noise level, the backseat passengers often lean towards the front passengers. Furthermore, all speakers raise their voices. Even if both reactions enhance the quality of the “communication channel” it is rather exhausting and uncomfortable for the passengers. The situation can be improved by using in-car communication systems.

### SUMMARY

An in-car communication system includes a first microphone arrangement in the vicinity of a first passenger position. The microphone arrangement is configured to pick up sound from the first passenger position and to convert the picked-up sound into a first electrical microphone signal. The system further includes a first loudspeaker arrangement in the vicinity of a second passenger position. The first loudspeaker arrangement is configured to convert a first electrical loudspeaker signal into sound radiated to the second passenger position. The system further includes a first signal processing module connected downstream of the first microphone arrangement and upstream of the first loudspeaker arrangement. The signal processing module is configured to process the first electrical microphone signal and to provide the first electrical loudspeaker signal. The first loudspeaker arrangement has a principal transmitting direction into which it radiates its maximum sound energy. The loudspeaker arrangement is disposed such that the radiated maximum sound energy is concentrated at the second passenger position.

An in-car communication method includes picking up sound from the first passenger position with a first microphone arrangement in the vicinity of a first passenger position and converting the picked-up sound into a first electrical microphone signal. The method further includes converting with a first loudspeaker arrangement in the vicinity of a second passenger position a first electrical loudspeaker signal into sound and radiating the sound to the second passenger position. The method further includes processing the first electrical microphone signal to provide the first electrical loudspeaker signal. The first loudspeaker arrangement has a principal transmitting direction into which it radiates its maximum sound energy. The loudspeaker arrangement is disposed such that the radiated maximum sound energy is concentrated at the second passenger position.

Other systems, methods, features and advantages will be, or will become, apparent to one with skill in the art upon examination of the following figures and detailed description. It is intended that all such additional systems, methods, features and advantages be included within this description, be within the scope of the invention and be protected by the following claims.

### BRIEF DESCRIPTION OF THE DRAWINGS

The system and method may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram illustrating the structure of a basic car interior communication system.

FIG. 2 is a diagram illustrating the average directivity of a human head.

FIG. 3 is a diagram illustrating the frequency responses of different communication directions within a passenger compartment.

FIG. 4 is a diagram depicting the results of the known Haas effect r.

FIG. 5 is a schematic diagram illustrating exemplary positions of electro dynamic planar loudspeakers in the roof liner in the interior of a car.

FIG. 6 is a diagram illustrating the transfer functions (magnitude frequency responses) from four electro dynamic planar loudspeakers disposed in the roof liner to four passenger positions in the set-up shown in FIG. 5.

FIG. 7 is a diagram illustrating the transfer functions (magnitude frequency responses) from four door loudspeakers of a conventional in-car audio system to four passenger positions in the set-up.

FIG. 8 is a schematic diagram illustrating exemplary four pairs of loudspeakers integrated in headrests in the interior of a car.

FIG. 9 is a schematic diagram of an exemplary headrest in which microphones and loudspeakers are integrated side by side in the front surface of the headrest, the microphones being arranged towards the center of the headrest and the loudspeakers being arranged towards the periphery of the headrest.

FIG. 10 is a schematic diagram of an exemplary headrest in which microphones and loudspeakers are integrated side by side in the front surface of the headrest, the microphones being arranged towards the periphery of the headrest and the loudspeakers being arranged towards the center of the headrest.

FIG. 11 is a schematic diagram of an exemplary headrest in which microphones and loudspeakers are integrated in the concave-shaped rounded front surface of the headrest, the microphones being arranged towards the center of the headrest and the loudspeakers being arranged towards the periphery of the headrest and elevated with regard to the microphones.

FIG. 12 is a schematic diagram of an exemplary headrest in which microphones and loudspeakers are integrated in the concave-shaped rounded front surface of the headrest, the loudspeakers being arranged towards the center of the headrest and the microphones being arranged towards the periphery of the headrest and elevated with regard to the loudspeakers.

FIG. 13 is a schematic diagram of an exemplary headrest in which microphones and loudspeakers are integrated in the concave-shaped rounded front surface of the headrest, the microphones being arranged at the front side of the loudspeakers.

FIG. 14 is a diagram illustrating the transfer functions (magnitude frequency responses) from the four pairs of headrest loudspeakers to the front left passenger position in the set-up shown in FIG. 8.

FIG. 15 is a diagram illustrating the transfer functions (magnitude frequency responses) from four pairs of headrest loudspeakers to the right rear passenger position in the set-up shown in FIG. 8.

FIG. 16 is a schematic diagram illustrating exemplary positions of four arrays of (miniature) loudspeakers in the roof liner in the interior of a car.

FIG. 17 is a diagram illustrating the transfer functions (magnitude frequency responses) from the four arrays of loudspeakers disposed in the roof liner to four passenger positions in the set-up shown in FIG. 16.

FIG. 18 is a schematic diagram illustrating exemplary positions of two arrays of (miniature) loudspeakers in the roof liner in the interior of a car between front passenger positions and rear passenger positions.

FIG. 19 is a diagram illustrating the transfer functions (magnitude frequency responses) from the two arrays of loudspeakers disposed in the roof liner to front right passenger position (left part of the diagram) and the rear left passenger position (right part of the diagram) in the set-up shown in FIG. 18.

FIG. 20 is a schematic diagram illustrating exemplary positions of two cross-wise arranged line arrays of (miniature) loudspeakers in the roof liner in the interior of a car between front passenger positions and rear passenger positions.

FIG. 21 is a block diagram illustrating a beamforming module applicable in connection with the set-up shown in FIG. 20.

FIG. 22 is a schematic diagram illustrating an exemplary set-up with a combination of two electro dynamic planar loudspeakers disposed in the roof liner between the front passenger positions and rear passenger positions and two pairs of loudspeakers disposed in the headrests at the front passenger positions.

FIG. 23 is a schematic diagram illustrating exemplary positions of microphones in the roof liner between the front passenger positions and rear passenger positions, and in the headrests at the front passenger positions.

FIG. 24 is a schematic diagram illustrating exemplary positions of microphones in the headrests at four passenger positions.

FIG. 25 is a schematic diagram illustrating exemplary positions of arrays of microphones in the roof liner between the front passenger positions and rear passenger positions, and pairs of microphones in the headrests at the front passenger positions.

FIG. 26 is a schematic diagram illustrating exemplary positions of arrays of microphones in the roof liner between the front passenger positions and rear passenger positions, and arrays of microphones in the roof liner in front of the front passenger positions.

FIG. 27 is a schematic diagram illustrating an exemplary first-order loudspeaker beamforming module.

FIG. 28 is a schematic diagram illustrating an exemplary first-order microphone beamforming module.

### DETAILED DESCRIPTION

In motor vehicles such as cars communication between passengers in the front and in the rear may be difficult—especially if the car is driven at medium or high speed, resulting in a large background noise level. Furthermore, driver and front passengers speak toward the windshield. Thus, they are hardly intelligible for those sitting behind them. To improve the speech intelligibility within a passenger compartment of a car, in-car communication systems are employed which record the speech of the speaking passengers by way of microphones and improve the communication by playing back the recorded signals via those loudspeakers located close to the listening passengers. These systems record the speech of each passenger with a single microphone or with an array of microphones. The recorded signals of the currently speaking passengers are processed by the system and played back via those loudspeakers which are located close to the non-active passengers. Comparable to public address systems, in-car communication systems operate within a closed electro-acoustic loop. Thus, signal processing is required to guarantee stable operation and to avoid acoustic feedback such as howling or whistling.

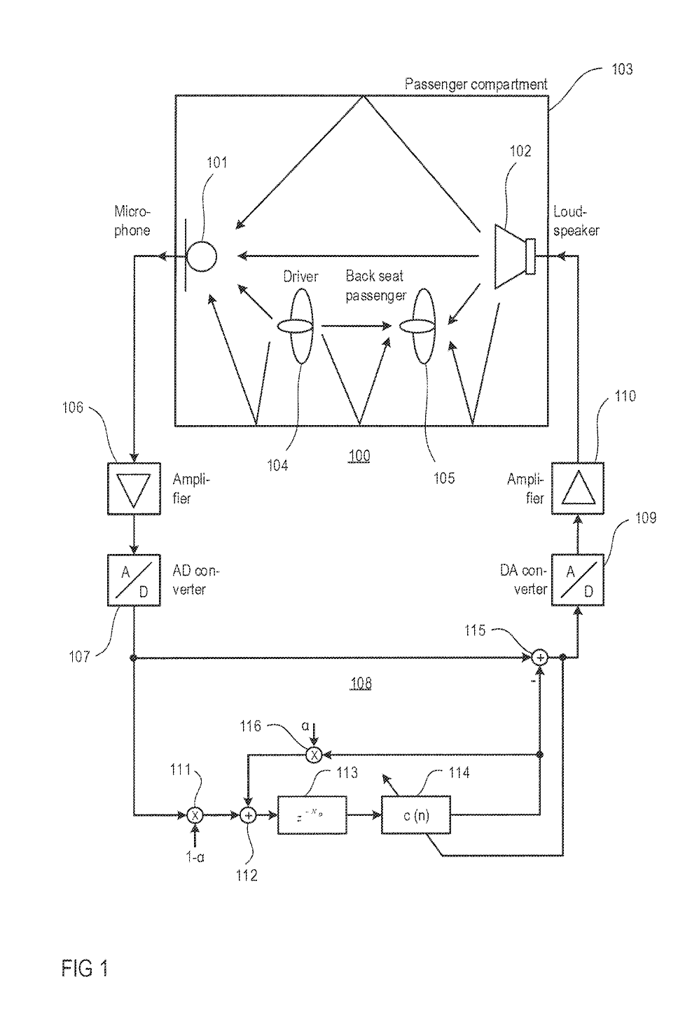

FIG. 1 shows a simplified structure of a simple car interior communication system 100 aimed, in this example, at supporting only front-to-rear conversations with one microphone 101 and one loudspeaker 102 arranged in a passenger compartment 103. A driver 104 is the speaking passenger and a back seat passenger 105 is the listening passenger in this example. The driver 104 sits in front of the back seat passenger 105, the microphone 101 is arranged in front of the driver 104 and the loudspeaker is located behind the back seat passenger 105. Electrical signals generated by the microphone 101 from picked-up sound are amplified by way of an analog amplifier 106 and supplied via a subsequent optional analog-to-digital converter 107 (in case of subsequent digital signal processing) to a signal processing module 108 which drives the loudspeaker 102 via an optional digital-to-analog converter 109 and a subsequent analog amplifier 110.

As can be seen in FIG. 1, in-car communication systems operate in a closed electro-acoustic loop. The microphone 101 picks up at least a portion of a signal radiated by loudspeaker 102. If this portion is not sufficiently small sustained oscillations appear, which can be heard as howling or whistling. The howling margin depends on the output gain of the in-car communication system as well as on the gains of the analog amplifiers 106 and 110. For this reason, all gains within the system need to be adjusted carefully. To improve the stability margin signal processing, such as beamforming, feedback and echo cancellation, adaptive notch filtering, adaptive gain adjustment, equalization, and nonlinear processing can be applied. A few basic processing units may include a coefficient element 111 (coefficient 1-α) connected downstream of the amplifier 106 (and optional AD converter 107), a subsequent adder 112, a subsequent filter 113 and an adaptive filter 114 are connected in series and linked to the signal provided by amplifier 106 (and optional AD converter 107) by way of a subtractor 115 as depicted in FIG. 1. The output of subtractor 115 is used to control adaptive filter 114 and the output of adaptive filter 114 is fed back via a coefficient element 116 (coefficient α) to adder 112.

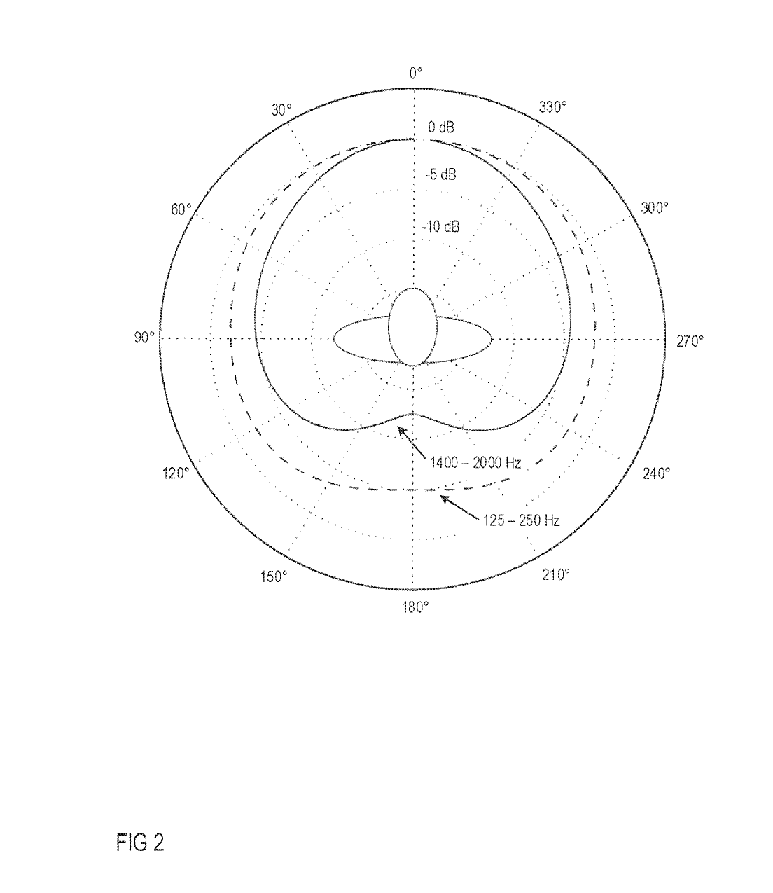

Because of the directivity of a human head as depicted for two frequency ranges in FIG. 2, it is harder to understand someone from behind than it is during an eye-to-eye conversation. In contrast to the rear passengers, driver and front seat passenger do not speak toward the listening communication partners. Thus, they are less intelligible. The frequency range from 1400 Hz to 2000 Hz, for example, is attenuated by more than 10 dB when listening to someone from behind (φ=180°) compared to an eye-to-eye communication. For this reason, it might be sufficient to enhance only the communication from front to rear within a passenger compartment. However, this is only true for (small) cars with only two seat rows. For larger cars such as limousines etc. an in-car communication system should support both directions. Another aspect that can be seen in FIG. 2 is that below approximately 300 Hz there is no significant directivity of the human head. For this reason, it might be sufficient to enhance only the communication above 300 Hz. Furthermore, enhancing the communication only above 300 Hz offers the advantage that the frequency range bearing the highest noise levels, which is below 300 Hz, is not restored into the electro-acoustic loop. Furthermore, speech signals below 500 Hz do not contribute considerably to speech intelligibility.

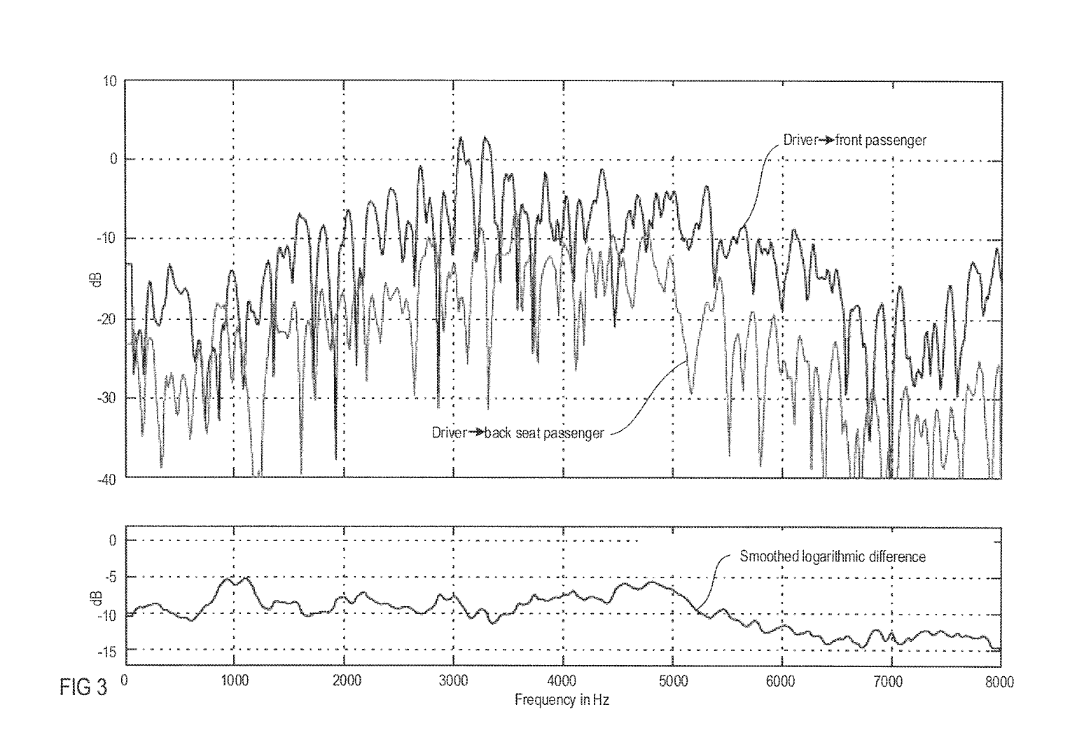

An analysis of the mouth-to-ear transfer functions within a car without an in-car communication system can be performed by placing a so-called artificial mouth loudspeaker at the speaker's seat, for example, driver's seat, and artificial ears, i.e., torsos with ear-microphones at the listeners' seats, for example, the front seat passenger and the rear passenger behind the front passenger. FIG. 3 shows the frequency responses measured between the driver's mouth and the left ear of the front seat passenger, as well as the left ear of the rear passenger behind the front passenger. On average the acoustic loss to the rear passenger is 5 to 15 dB larger (compared to the front passenger). If one assumes that even in the presence of a considerable amount of noise the communication quality—in terms of speech intelligibility—between two passengers sitting in the same row of seats within a car is at least sufficient, such measurements give a first idea about the required gain of in-car communication systems for enhancing front-to-rear communications. A reasonable dynamic range may be, for example, between 10 dB and 15 dB.

Furthermore, the amount of required gain varies in relation to the distance of the front and rear seat rows and is dependent on the materials which line the passenger compartment. Diffuse field distances measured in various cars indicate that up to a distance of 1.5 m the radiated acoustic power decreases with 1/r2, wherein r describes the distance from the sound source. Thus, the larger the distance between speaking and listening passenger is, the more gain is required. Furthermore, most materials utilized for lining passenger compartments absorb high frequency sound energy better than low frequency energy. As a consequence, it is more important to enhance medium and high frequencies than low ones if the speech intelligibility should be improved.

Another aspect is how much “enhancement” in terms of amplification is required. In most cars the speech intelligibility is good or at least sufficient if the car is not driving. In such a scenario, an in-car communication system would make the car sound more reverberant and, thus, reduce the communication quality. However, at medium or high speed things change and an intercom system is able to enhance the speech intelligibility considerably. However, because of the known Lombard effect, it is not necessary to also increase the amplification of an in-car communication system by 30 dB. Any person who speaks in a noisy environment will automatically alter the speech characteristics in order to increase the efficiency of communication over the noisy channel.

Another limiting condition is that visual and acoustic source localization should match. This is especially a problem for the rear passengers since they see the front passengers in front of them. However, if the rear loudspeakers are installed behind the back seats and the gain of these loudspeakers is too high, the acoustic localization indicates that the speaking person is behind the listening one. This mismatch of different senses causes a very unnatural impression of the communication. To avoid such unnatural impression, the gain of the rear loudspeakers may be limited according to the delay between the primary source (e.g., the driver) and the secondary source (e.g., loudspeaker in the back). The amount of amplification until the localization mismatch effect appears is given by the so-called law of the first wave front, also known as Haas effect.

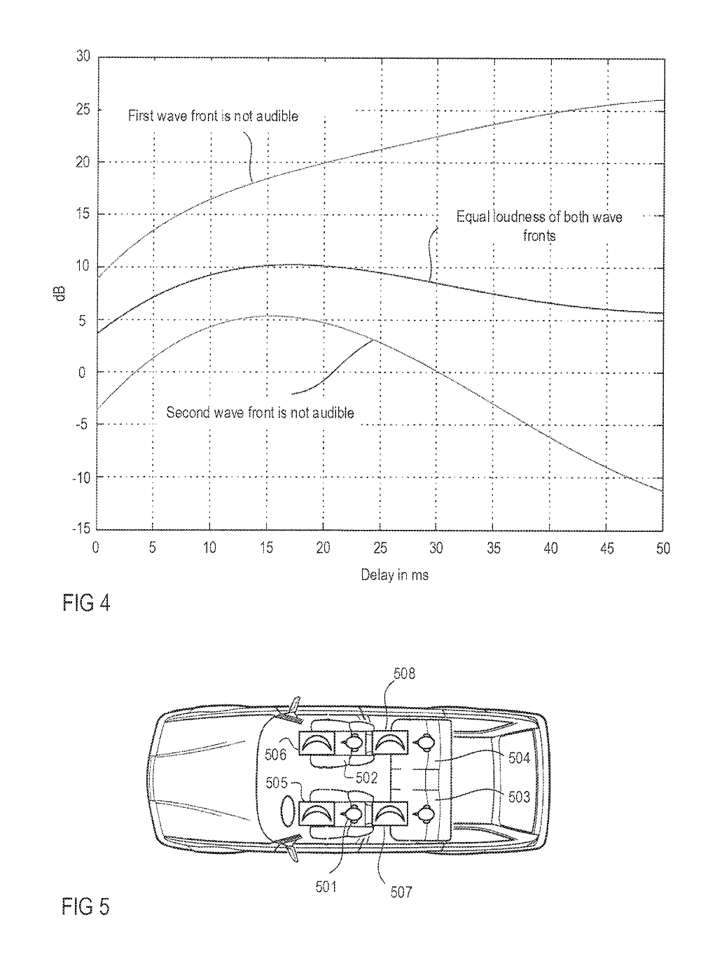

In FIG. 4, the results of a known psycho-acoustic experiment are depicted as gain [dB] vs. delay time [ms], in which two loudspeakers were placed at angles of 40° and −40° in front of a listener. Both loudspeakers emit a prerecorded speech signal but one of the loudspeakers was delayed by a few milliseconds. About 20 subjects were asked to adjust the gain of the delayed loudspeaker until they had the impression that a) the loudness of both loudspeakers is about the same, b) the signal of the earlier loudspeaker is not audible any more, and c) the delayed loudspeaker is not audible any more. As one can see in FIG. 4, a second loudspeaker, which emits a 15 ms delayed signal, can be amplified by 10 dB to 12 dB until the impression of equal loudness from both directions is achieved. The overall loudness, however, could be increased by 10 to 12 dB. These results correspond very well with experiments made within cars. Rear loudspeakers in an in-car communication system can significantly improve the loudness without changing the acoustically perceived localization of the source. For example, at a delay of 10 to 20 ms adequate results can be achieved. However, the maximum gain has to be adjusted carefully and individually for each type of car. Besides the Haas effect, another effect related to latency involves induced echoes, i.e., a speaker perceives his/her own voice with a certain delay. Such echoes are tolerable when the delay time is below approximately 10 ms.

Sufficient crosstalk attenuation between different seating positions would allow to reduce or even overcome the drawbacks outlined above, particularly the feedback effect and the echo effect. To increase crosstalk attenuation the directivity of the loudspeakers may be increased, for example, by using more directional loudspeakers and/or by adequate signal processing. Directional loudspeakers are loudspeakers that concentrate acoustic energy at a particular listening position. In other words, a directional loudspeaker (or a directional arrangement of loudspeakers) has a principal transmitting direction into which it radiates its maximum sound energy, whereby the loudspeaker (arrangement) is disposed such that the radiated maximum sound energy is concentrated at the respective passenger position. A passenger position is herein referred to as the position relative to the car interior floor or roof.

Referring to FIG. 5, an exemplary in-car communication system may include four passenger positions in a car cabin: front left passenger position 501, front right passenger position 502, rear left passenger position 503 and a rear right passenger position 504. In the vicinity of any of passenger positions 501-504, a signal representing sound picked-up at any other position 501-504 may be reproduced. Vicinity of a passenger position means that a microphone or loudspeaker is closer to this particular position than to any other passenger position. To pick up sound, microphones (not shown) may be mounted at the positions 501-504 close to an average passenger's mouth when sitting in positions 501-504. In the present case, shallow loudspeakers 505-508, such as electro dynamic planar loudspeakers (EDPL), are integrated in the roof liner above the positions 501-504. The loudspeakers may be slanted in order to increase crosstalk attenuation between the front and rear sections of the car cabin. The distance between the passenger's ears and the corresponding loudspeaker may be kept as short as possible to further increase crosstalk attenuation. For example, the distance may be below 0.5 m or even below 0.3 m.

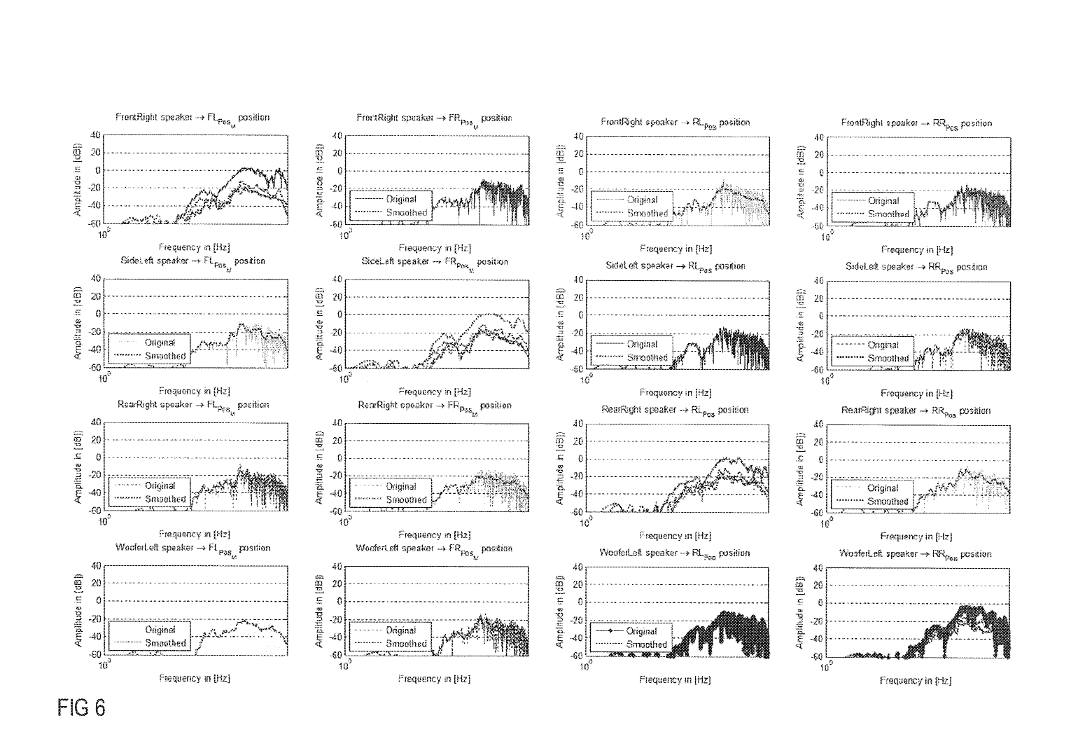

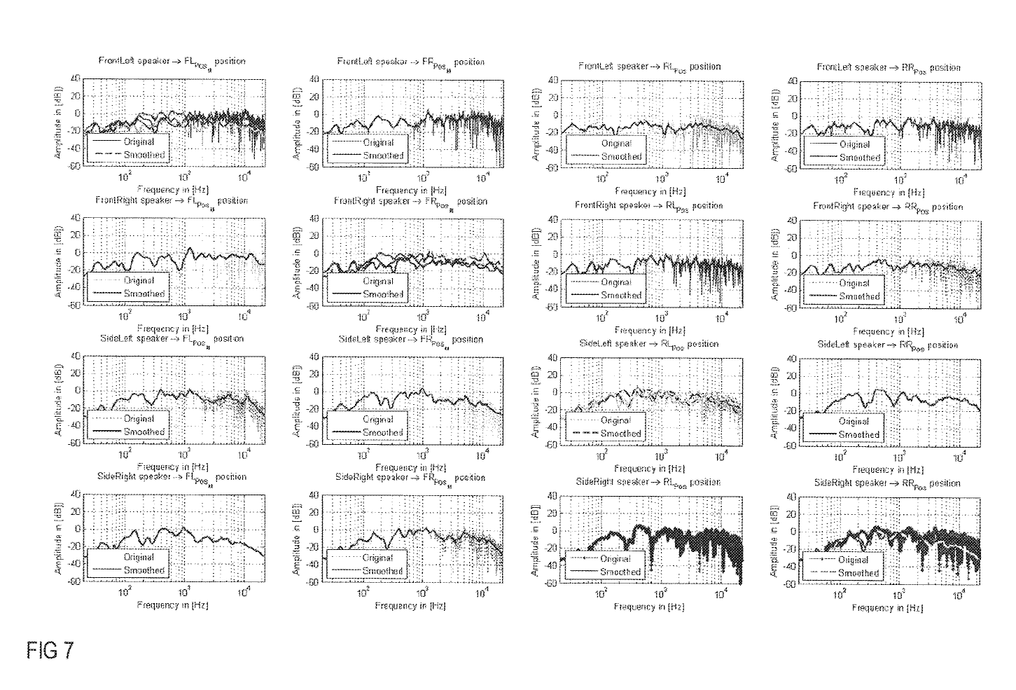

FIG. 6 depicts results of measurements conducted with a set-up with EDPLs as shown in FIG. 5 recorded at microphones installed in all headrests (two per piece). FIG. 7 shows the results when using a common set-up using four door loudspeakers of a car entertainment system. As can be seen from a comparison between FIGS. 6 and 7, which are magnitude frequency responses diagrams for various combinations of loudspeakers and passenger positions, as well as microphone positions, the set-up shown in FIG. 6 exhibits an operating frequency range that is above approximately 300 Hz. Furthermore, it can be seen in FIG. 6 that the crosstalk attenuation is in average 2 dB to 3 dB lower between adjacent positions (e.g., the two front positions or the two rear positions) than between a front position and a rear position.

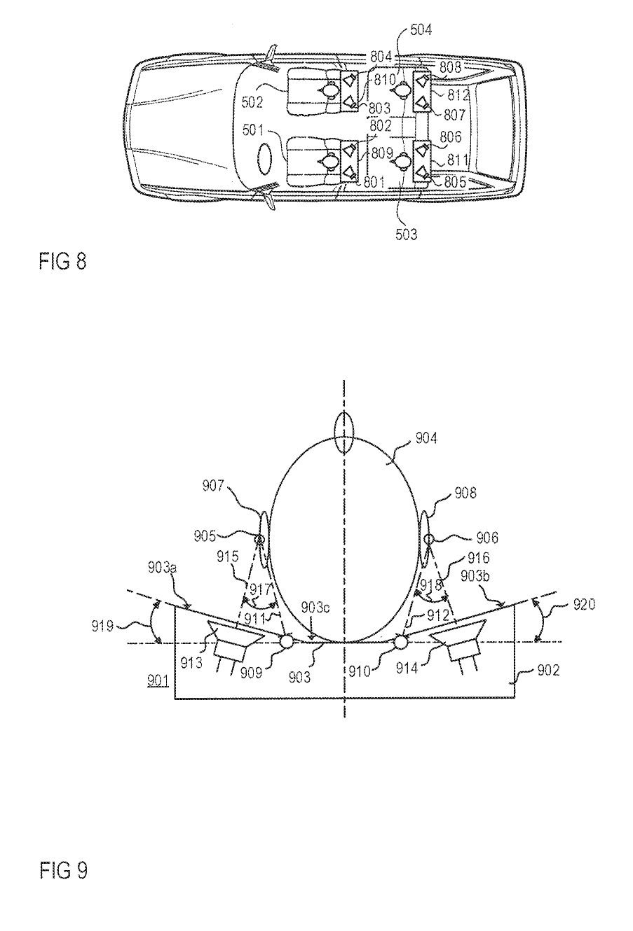

In order to further improve the crosstalk attenuation, particularly at higher frequencies, the distance between the passenger's ears and the corresponding loudspeakers may be reduced by, alternatively or additionally to integrating directional loudspeakers into the roof lining, (directional) loudspeakers 801-808 may be integrated into headrests 809-812 of passenger seats at the passenger positions, as shown in FIG. 8, so that the distance between the passenger's ears and the corresponding loudspeakers is further reduced and the headrests of the front seats would provide further crosstalk attenuation between the front seats and the rear seats.

Reference is now made to FIG. 9, which depicts an exemplary headrest 901 in a sectional illustration. Headrest 901 may have a cover and one or more structural elements that form headrest body 902. Headrest 901 may comprise a pair of support pillars (not shown) that engage the top of a vehicle seat (not shown) and may be movable up and down by way of a mechanism integrated in the seat. Headrest body 902 has front surface 903 that supports user's head 904, thereby defining preferential positions 905 and 906 of user's ears 907 and 908. Preferential positions are where the respective ear is at or close to this particular position most of the time (>50%) during intended use.

Two unidirectional microphones 909 and 910, i.e., microphones that have a maximum sensitivity to sounds from principal receiving directions 911 and 912, are integrated in front surface 903 of headrest body 902, whereby principal receiving directions 911 and 912 intersect with one of preferential positions 905 and 906 of user's ears 907 and 908, respectively. Headrest 901 further includes two loudspeakers 913 and 914 integrated in headrest body 902. Loudspeakers 913 and 914 each have principal transmitting directions 915, 916 into which they radiate maximum sound energy. Headrest 901 has at its surface 903 an inward-curving (concave) shape with two planar end sections 903a, 903b and a planar intermediate section 903c in which the end sections are folded inwards by angles 919 and 920, respectively, of about 30 degrees, but other angles between 0 and 50 degrees is applicable as well. In each of the end sections, one of microphones 909 and 910 and one of loudspeakers 913 and 914 are positioned. In headrest 901 of FIG. 1, loudspeakers 913 and 914 are arranged closer to the outer periphery of surface 3 than microphones 9 and 10. Loudspeakers 913 and 914 are arranged such that their principal transmitting directions 915 and 916 each have one of angles 917 and 918 at preferential positions 905 and 906 of greater than 20 degree, for example, 30 degrees with regard to the respective principal receiving directions of microphones 909 and 910.

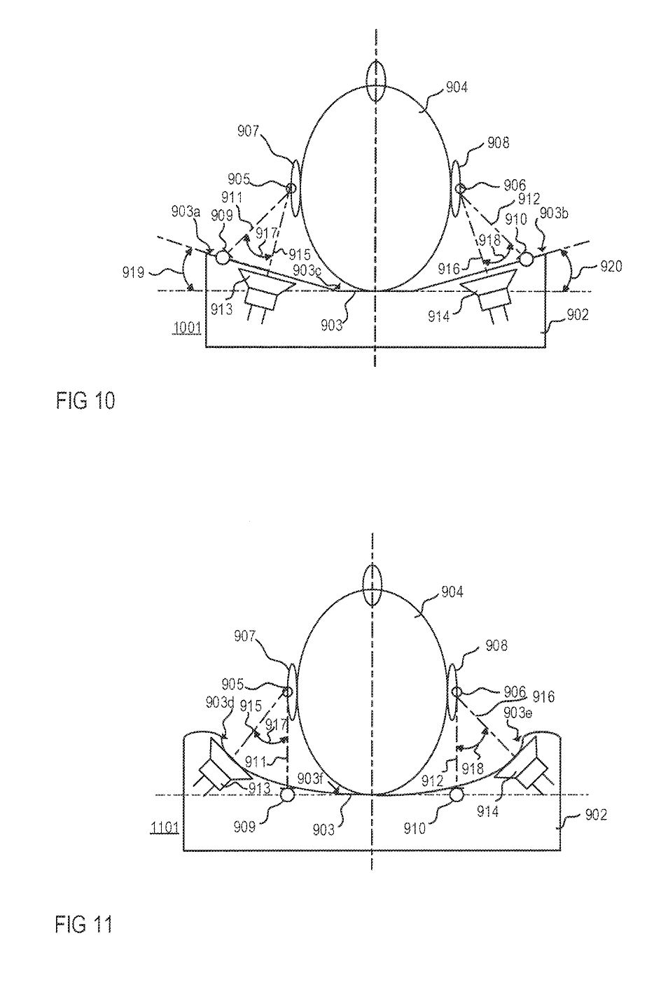

A headrest 1001 shown in FIG. 10 is similar to headrest 901 shown in FIG. 9, however, the microphone positions and loudspeaker positions have been reversed and all positions have been shifted towards the outer peripheries of planar end sections 903a and 903b of front surface 903. Loudspeakers 913 and 914 are arranged such that their principal transmitting directions 915 and 916 have angles 917 and 918 at preferential positions 905 and 906 of greater than 30 degrees with regard to the respective principal receiving direction of microphones 909 and 910.

A headrest 1101 as shown in FIG. 11 is similar to headrest 901 of FIG. 1, however, front surface 903 of the headrest has an inward-curving, rounded shape extending much further around the longitudinal axis of head 904, and it has curved end sections 903d and 903e and a curved intermediate section 903f Loudspeakers 913 and 914 are arranged in peripheral sections 903d and 903e of headrest 901 and thus have a more laterally protruding level from intermediate section 903f of surface 903 than in the previous examples. Microphones 909 and 910 are positioned approximately behind user's ears 907 and 908. Accordingly, loudspeakers 913 and 914 are arranged such that their principal transmitting directions 915 and 916 have angles 917 and 918 at preferential positions 905 and 906 of greater than 45 degrees with regard to the respective principal receiving direction of microphones 909 and 910.

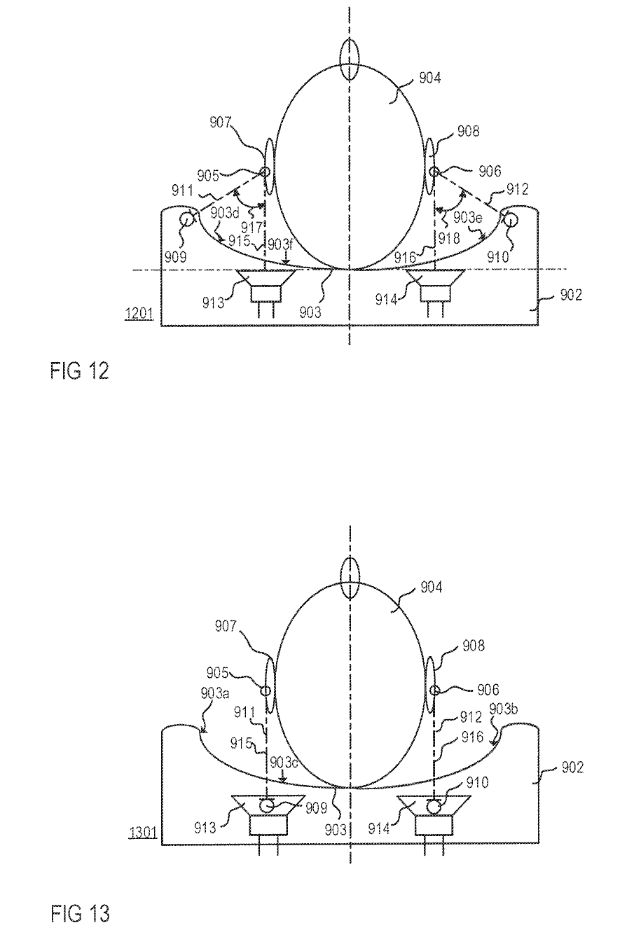

A headrest 1201 as shown in FIG. 12 is similar to headrest 901 of FIG. 11, however, the microphone positions and loudspeaker positions are reversed and the positions of the microphones have been shifted towards the outer peripheries of curved end sections 903d and 903e of front surface 903. A headrest 1301 as shown in FIG. 13 is similar to headrest 901 of FIG. 12, however, the microphone positions are here close to the loudspeaker positions at the loudspeakers' front sides.

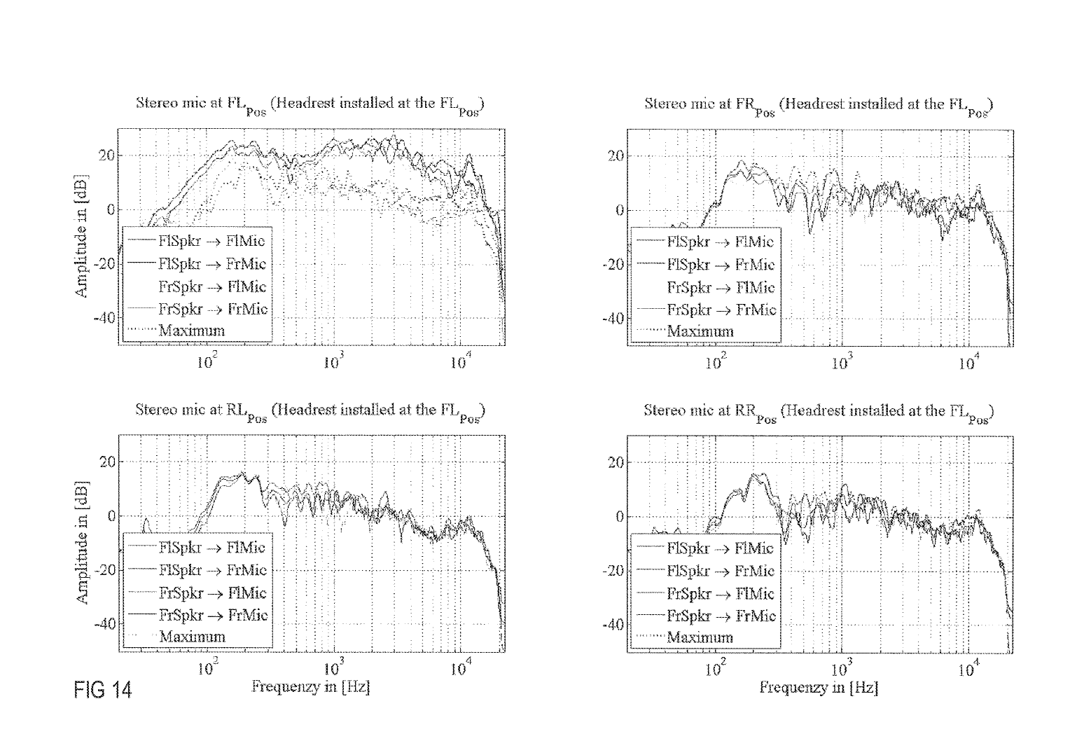

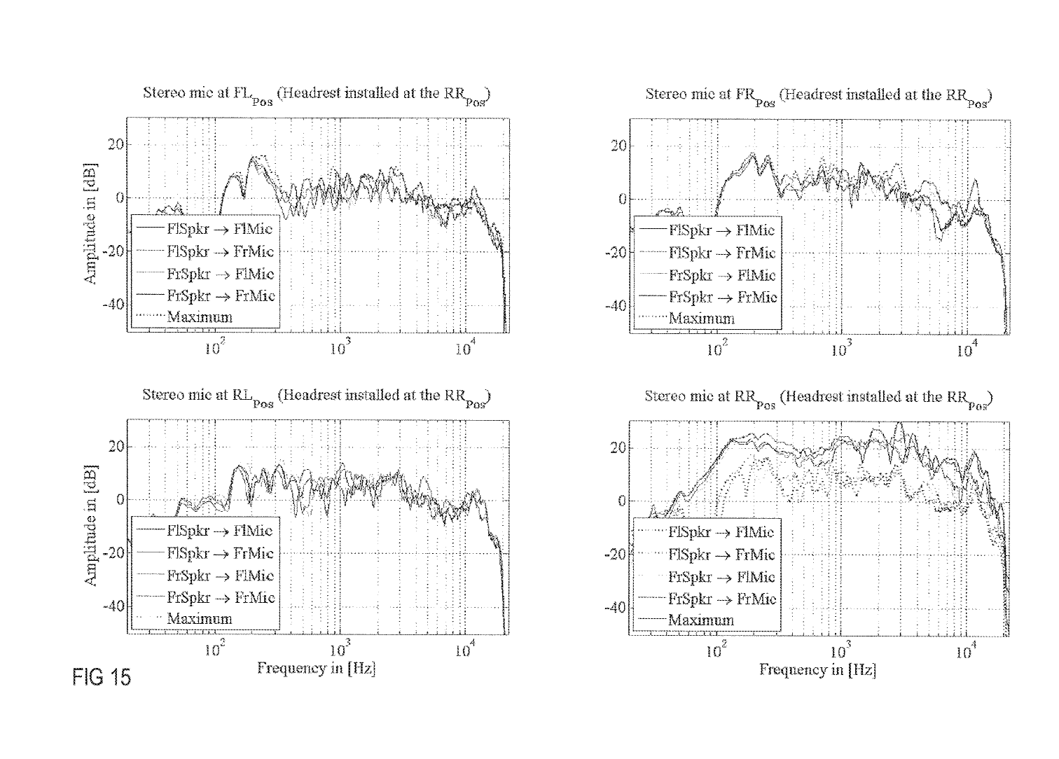

FIG. 14 depicts the magnitude frequency response for various combinations of headrest loudspeakers and microphones that are disposed in all headrests and the headrest loudspeakers at the front left position. In FIG. 14, the left and right loudspeakers of the headrest are referred to as FlSpkr and FrSpkr; the left and right microphones in the headrests are referred to as FlMic and FrMic. FIG. 15 depicts the magnitude frequency responses for various combinations of headrest loudspeakers and microphones that are disposed in all headrests and the active headrest loudspeakers at the rear-right position. In FIG. 15, the left and right loudspeakers of the headrest are again referred to as FlSpkr and FrSpkr; the left and right headrest microphones are again referred to as FlMic and FrMic. As can be seen from a comparison of FIGS. 14 and 15, loudspeakers disposed in a headrest can provide some crosstalk attenuation which is not present over the full spectral range of the loudspeaker and which varies over frequency, but can provide sufficient crosstalk attenuation of approximately 15 dB above approximately 1 kHz.

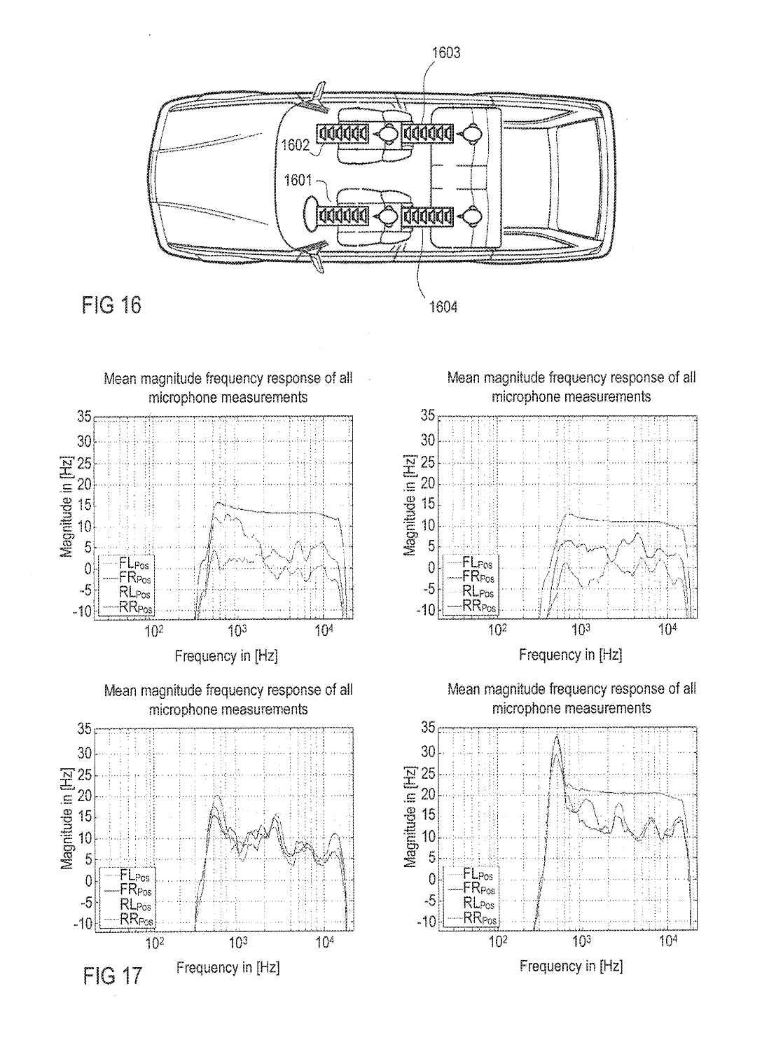

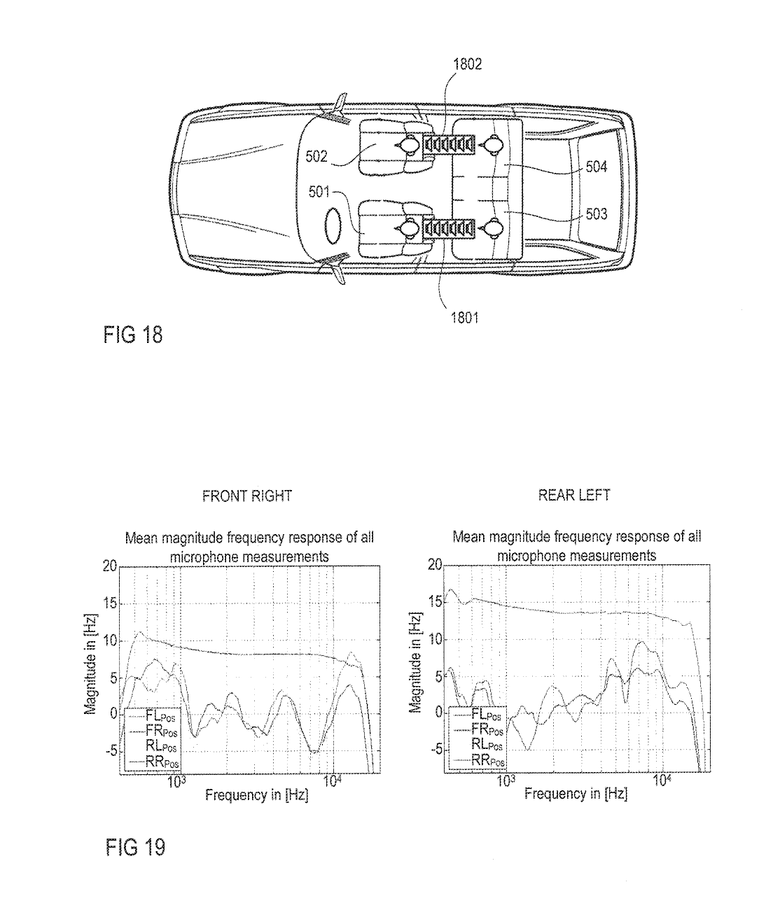

In the set-up shown in FIG. 16, a multiplicity of small loudspeakers, such as loudspeakers used, for example, in smartphones, are disposed in four lines and form four arrays 1601-1604 of loudspeakers. In the example shown in FIG. 16, each of the arrays 1601-1604, is disposed in the roof liner in front of one of the four passenger positions. Each of the arrays 1601-1604 may be mounted in a rigid, sealed box and the loudspeakers of each array may be connected to a signal processing circuit to provide beamforming functionality. The beamforming functionality may be designed to provide maximum sound pressure at the passenger position closest to the particular array (bright zone) and minimum sound pressure at the other passenger positions (dark zones). FIG. 17 depicts cross-talk attenuations between the bright zone and the dark zones to be expected in a set-up as shown in FIG. 16. As can be seen crosstalk attenuation of up to 15 dB can be achieved, particularly between the front seat positions and the rear seat positions in case of line arrays provided at front seat positions. Additionally, the signals supplied to the line arrays disposed in rear seat positions may be delayed to reduce the latency (Haas effect) so that echoes can be reduced and the system can be operated with higher dynamics, which produces a higher intelligibility.

In another example, loudspeaker line arrays 1801 and 1802 are only disposed in the rear seat positions. Each of the line arrays 1801 and 1802 is designed to provide two sound beams, one to the corresponding rear seat and the other to the corresponding front passenger position 501, 502 straight in front of this particular rear passenger position 503, 504. The sound beams can be generated by acoustic design, beamforming circuitry, software, or a combination of them. The sound beams provide different information, i.e., the signals intended to be perceived by the respective passenger to the different positions 501-504. The results that can be achieved are depicted in FIG. 19 and illustrate that again sufficient crosstalk attenuation can be produced.

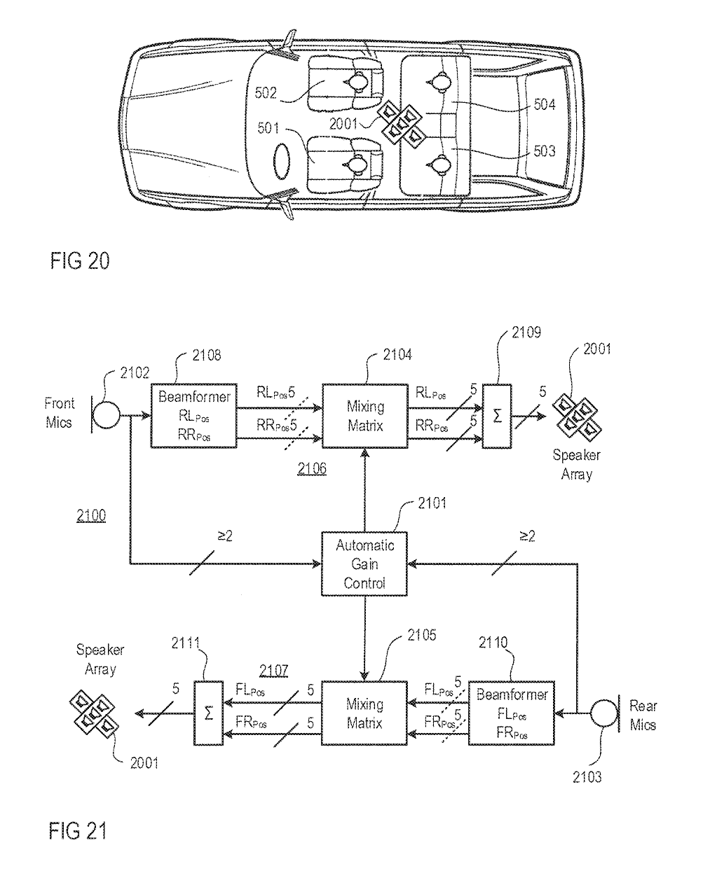

Another exemplary set-up, which is shown in FIG. 20, employs only one loudspeaker array, cross array 2001, in which the loudspeakers are arranged in a cross-like pattern. However, any other shape can be used in connection with appropriate (electronic) beamforming. The cross array 2001 is disposed to produce (maybe in connection with appropriate signal processing) 4 sound beams directed to each of the four passenger positions 501-504. The sound beams provide different information, i.e., the signals intended to be perceived by the respective passenger, to the different positions 501-504.

Referring to FIG. 21, a beamforming module 2100 applicable in the system shown in FIG. 20 may include an automatic gain control sub-module 2101. Modules and sub-modules as described herein may be pure hardware or mixed hardware and software. The automatic gain control sub-module 2101 receives input signals from a multiplicity of (which is at least two) front microphones 2102 disposed in the front part of the car interior and a multiplicity of (which is at least two) rear microphones 2103 disposed in the rear part of the car interior. The automatic gain control sub-module 2101 controls mixing matrix sub-modules 2104 and 2105 for the rear positions 2106 and the front positions 2107. Right channel 2106 includes, besides the mixing matrix sub-module 2104, a beamformer sub-module 2108 connected between the multiplicity of front microphones 2102 and the mixing matrix sub-module 2104, and a summer 2109 connected between the mixing matrix sub-module 2104 and the loudspeaker array 2001. Similarly, left channel 2107 includes, besides the mixing matrix sub-module 2105, a beamformer sub-module 2110 connected between the multiplicity of rear microphones 2103 and the mixing matrix sub-module 2105, and a summer 2111 connected between the mixing matrix sub-module 2105 and the loudspeaker array 2001. The beamforming module 2100 is designed to generate via the loudspeaker array 2001 four audio beams with different (information) content.

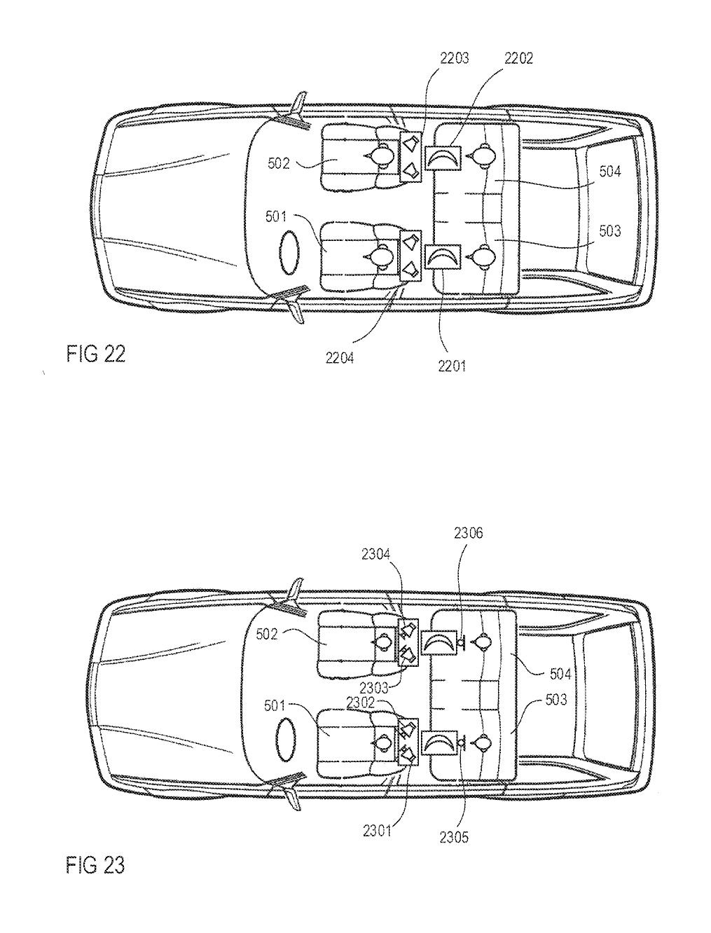

In order to achieve even higher crosstalk attenuation, different types of directional loudspeakers may be combined as shown in FIG. 22 in which EDPLs 2201 and 2202 disposed in the roof lining in front of the rear passengers are combined with loudspeakers 2203 and 2204 disposed in the headrests of the front seats. With such a set-up crosstalk attenuation of about 15 dB with the headrest loudspeakers 2203 and 2204 which support the communication from the rear to the front, and about 20 dB with the EDPLs 2201 and 2202 which support the communication from the front to the rear, can be achieved. The use of directional loudspeakers allows for higher system dynamics (difference between the highest and lowest amplitude levels), as the loudspeakers are closer to the passengers, a more natural sound perception of the passengers as the direction of sound arrival is correctly defined, and a better speech intelligibility, since less electronic signal processing is required to, for example, avoid anti-howling signal processing blocks as shown in FIG. 1.

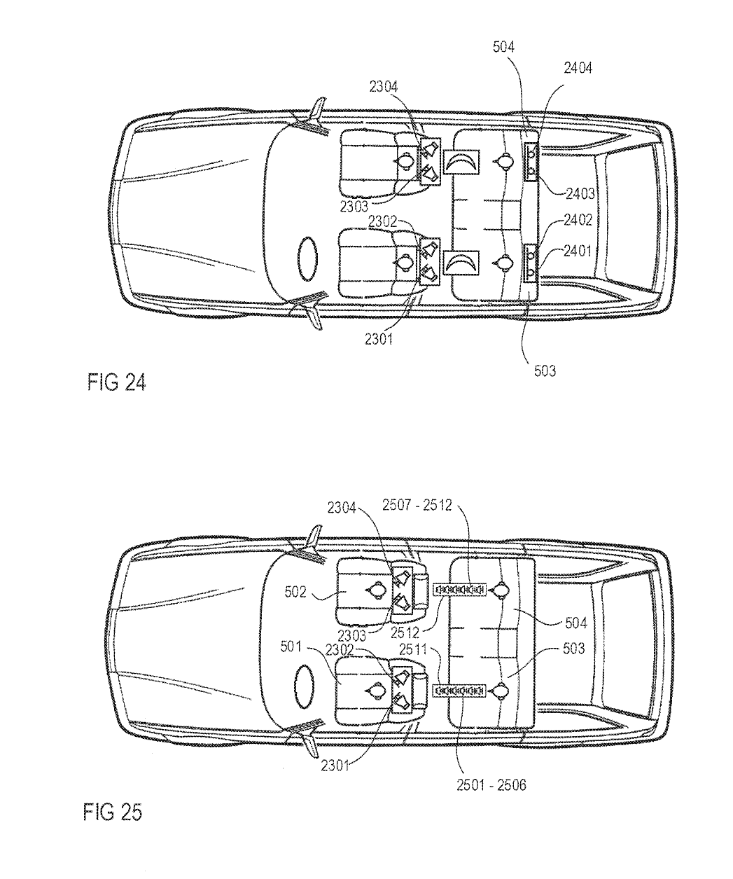

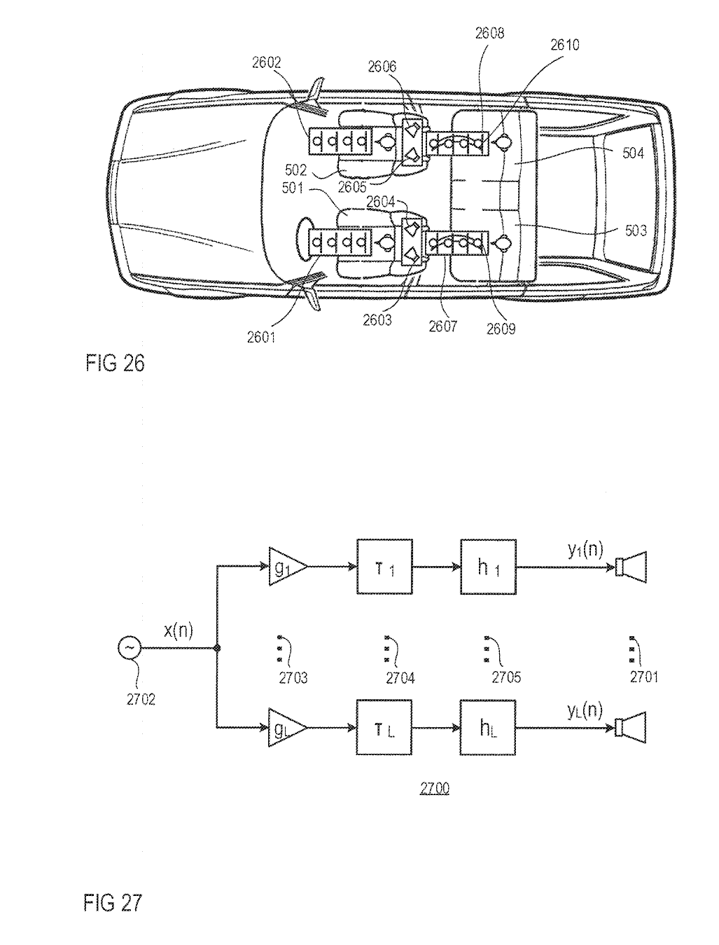

FIGS. 23-26 illustrate various exemplary ways to arrange front microphones and rear microphones in the car interior. In the set-up shown in FIG. 23, which is based on the set-up shown in FIG. 22, four front microphones 2301-2304 are disposed in pairs (possibly in a similar manner as the loudspeakers) in the headrests of the seats at the front positions 501 and 502, and two rear microphones in the roof liner in front of the rear passenger positions 503 and 504 (possibly adjacent to the EDPLs). In the set-up shown in FIG. 24, which is also based on the set-up shown in FIG. 22, the four front microphones 2301-2304 are again disposed in pairs (together with loudspeakers) in the headrests of the seats at the front positions 501 and 502, and four rear microphones 2401-2404 are disposed in pairs in the headrests of the seats at the rear positions 503 and 504. In the set-up shown in FIG. 25, which is also based on the set-up shown in FIG. 22 but with loudspeaker line arrays 2511 and 2512 instead of EPLs, the four front microphones 2301-2304 are again disposed in pairs (together with loudspeakers) in the headrests of the seats at the front positions 501 and 502, and twelve rear microphones 2501-2512 are disposed in the line arrays, six microphones per line array, in front of the rear passenger positions 503 and 504. In the set-up shown in FIG. 26, at the front positions 501 and 502, microphone line arrays 2601 and 2602 are disposed in the roof liner in front of the front passenger positions 501 and 502 and loudspeakers 2603-2606 are disposed in pairs in the headrests of the seat at the front passenger positions 501 and 502. EDPLs 2607 and 2608, which are combined with microphone line arrays 2609 and 2610, are disposed in the roof liner in front of the rear passenger positions 503 and 504.

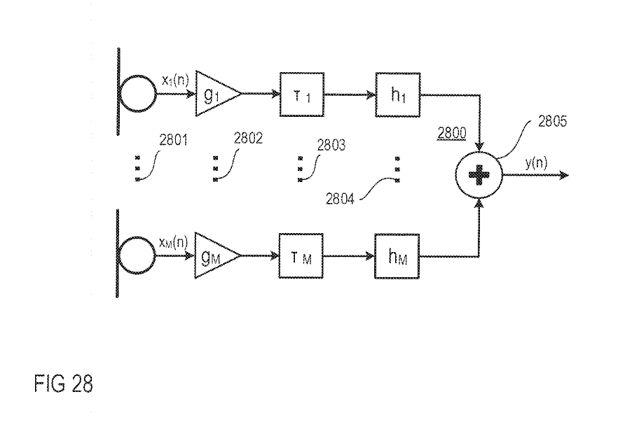

FIG. 27 is a block diagram illustrating an exemplary loudspeaker beamforming module 2700 for providing more directional characteristics with an array of loudspeakers 2701 that may be disposed in a headrest or roofliner. In the loudspeaker beamforming module 2700, an input signal x(n) from a signal source 2702 is amplified or attenuated by gain elements 2703 having gains g₁-g_{L}, whose output signals are then delayed by delay times τ₁-τ_{L} in subsequent delay paths 2704 before being filtered by beamforming filter 2705 with transfer functions h₁-h_{L} to provide output signals y₁(n)-yL(n) to the loudspeakers 2701. In a similar manner as with loudspeakers, a multiplicity of microphones may be connected to a beamforming module, i.e. a microphone beamforming module 2800, which may make an in-car communication system still more robust against feedback effects such as, for example, howling since less noise is picked-up and processed by the in-car communication system. FIG. 28 is a schematic representation of the microphone beamforming module 2800 which receives sound from a sound source (not shown). Beamforming module 2800 comprises M microphones 2801 disposed, for example, as an array. Electrical signals x₁(n)-x_{M}(n) generated by the microphones 2801 are amplified or attenuated by M parallel gain elements 2802 having gains g₁ . . . g_{M} and are then delayed by delay times τ₁-τ_{M} in subsequent M delay paths 2803 before being filtered by M beamforming filter 2804 with transfer functions h₁-h_{M} and summed up by a summer 2805 to provide an output signal y(t). Accordingly, by arranging and connecting the microphones in the way described above in connection with FIG. 28, M omnidirectional microphones 2801 may form a unidirectional microphone constellation, i.e., the M omnidirectional microphones together behave like at least one unidirectional microphone.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. An in-car communication system comprising:
a first microphone arrangement in the vicinity of a first passenger position; the first microphone arrangement being configured to pick up sound from the first passenger position and to convert the picked-up sound into a first electrical microphone signal;
a first loudspeaker arrangement in the vicinity of a second passenger position; the first loudspeaker arrangement being configured to convert a first electrical loudspeaker signal into sound radiated to the second passenger position; and
a first signal processing module connected downstream of the first microphone arrangement and upstream of the first loudspeaker arrangement; the first signal processing module being configured to process the first electrical microphone signal and to provide the first electrical loudspeaker signal; wherein
the first loudspeaker arrangement has a principal transmitting direction into which it radiates its maximum sound energy, the first loudspeaker arrangement being disposed such that the radiated maximum sound energy is concentrated at the second passenger position.

2. The in-car communication system of claim 1, wherein the first loudspeaker arrangement comprises a first electro dynamic planar loudspeaker.

3. The in-car communication system of claim 1, wherein the first loudspeaker arrangement comprises a first array of loudspeakers.

4. The in-car communication system claim 3, the first signal processing module comprises a first beamforming module, the first beamforming module being configured to provide the first electrical loudspeaker signal and additional first electrical loudspeaker signals for each loudspeaker of the first array of loudspeakers, the first electrical loudspeaker signal and the additional first electrical loudspeaker signals being configured to further concentrate the maximum sound energy to the second passenger position.

5. The in-car communication system of claim 1, further comprising:
a second microphone arrangement in the vicinity of the second passenger position; the second microphone arrangement being configured to pick up sound from the second passenger position and to convert the picked-up sound into a second electrical microphone signal;
a second loudspeaker arrangement in the vicinity of the first passenger position; the second loudspeaker arrangement being configured to convert an second electrical loudspeaker signal into sound radiated to the first passenger position; and
a second signal processing module connected downstream of the second microphone arrangement and upstream of the second loudspeaker arrangement; the second signal processing module being configured to process the second electrical microphone signal and to provide the second electrical loudspeaker signal; wherein
the second loudspeaker arrangement has a principal transmitting direction into which it radiates its maximum sound energy, the second loudspeaker arrangement being disposed such that the radiated maximum sound energy is concentrated at the first passenger position.

6. The in-car communication system of claim 5, wherein at least one of first loudspeaker arrangement and second loudspeaker arrangement is disposed in a roof lining of a car interior.

7. The in-car communication system of claim 5, wherein at least one of first loudspeaker arrangement and second loudspeaker arrangement is disposed in a headrest.

8. The in-car communication system of claim 5, wherein the second loudspeaker arrangement comprises an electro dynamic planar loudspeaker.

9. The in-car communication system of claim 5, wherein at least one of the first loudspeaker arrangement and the second loudspeaker arrangement is disposed between the first passenger position and the second passenger position.

10. The in-car communication system of claim 5, wherein at least one of first microphone arrangement and the second microphone arrangement is disposed in a roof lining of a car interior or a headrest and/or an array of microphones.

11. The in-car communication system of claim 5, wherein the second loudspeaker arrangement comprises an array of loudspeakers.

12. The in-car communication system claim 11, the second signal processing module comprises a beamforming module, the beamforming module being configured to provide the second electrical loudspeaker signal and additional second electrical loudspeaker signals for each loudspeaker of the array of loudspeakers, the second electrical loudspeaker signal and the additional second electrical loudspeaker signals being configured to further concentrate the maximum sound energy to the first passenger position.

13. The in-car communication system of claim 12, wherein at least one of first microphone arrangement and the second microphone arrangement is connected to at least one additional beamforming module configured to control a directivity of the first microphone arrangement and the second microphone arrangement.

14. An in-car communication method comprising:
picking up sound from a first passenger position with a first microphone arrangement in the vicinity of a first passenger position and converting the picked-up sound into a first electrical microphone signal;
converting with a first loudspeaker arrangement in the vicinity of a second passenger position a first electrical loudspeaker signal into sound and radiating the sound to the second passenger position; and
processing the first electrical microphone signal to provide the first electrical loudspeaker signal; wherein
the first loudspeaker arrangement has a principal transmitting direction into which it radiates its maximum sound energy, the first loudspeaker arrangement being disposed such that the radiated maximum sound energy is concentrated at the second passenger position.

15. The in-car communication method of claim 14, further comprising:
a second microphone arrangement in the vicinity of the second passenger position;
the second microphone arrangement being configured to pick up sound from the second passenger position with a second microphone arrangement in the vicinity of the second passenger position, and convert the picked-up sound into an second electrical microphone signal;
converting with a second loudspeaker arrangement in the vicinity of the first passenger position an second electrical loudspeaker signal into sound and radiating the sound to the first passenger position; and
processing the second electrical microphone signal to provide the second electrical loudspeaker signal; wherein
the second loudspeaker arrangement has a principal transmitting direction into which it radiates its maximum sound energy, the second loudspeaker arrangement being disposed such that the radiated maximum sound energy is concentrated at the first passenger position.

16. An in-car communication system comprising:
a first microphone arrangement in the vicinity of a first passenger position; the first microphone arrangement being configured to pick up sound from the first passenger position and to convert the picked-up sound into a first electrical microphone signal;
a first loudspeaker arrangement in the vicinity of a second passenger position; the first loudspeaker arrangement being configured to convert a first electrical loudspeaker signal into sound radiated to the second passenger position; and
a first signal processing module connected to the first microphone arrangement and the first loudspeaker arrangement; the first signal processing module being configured to receive the first electrical microphone signal and to provide the first electrical loudspeaker signal; wherein
the first loudspeaker arrangement being configured to radiate a maximum sound energy into a principal transmitting direction, the first loudspeaker arrangement being disposed such that the radiated maximum sound energy is concentrated at the second passenger position.

17. The in-car communication system of claim 16, wherein the first loudspeaker arrangement comprises a first electro dynamic planar loudspeaker.

18. The in-car communication system of claim 16, wherein the first loudspeaker arrangement comprises a first array of loudspeakers.

19. The in-car communication system claim 18, the first signal processing module comprises a first beamforming module, the first beamforming module being configured to provide the first electrical loudspeaker signal and additional first electrical loudspeaker signals for each loudspeaker of the first array of loudspeakers, the first electrical loudspeaker signal and the additional first electrical loudspeaker signals being configured to further concentrate the maximum sound energy to the second passenger position.

20. The in-car communication system of claim 1, further comprising:
a second microphone arrangement in the vicinity of the second passenger position; the second microphone arrangement being configured to pick up sound from the second passenger position and to convert the picked-up sound into a second electrical microphone signal;
a second loudspeaker arrangement in the vicinity of the first passenger position; the second loudspeaker arrangement being configured to convert an second electrical loudspeaker signal into sound radiated to the first passenger position; and
a second signal processing module connected downstream of the second microphone arrangement and upstream of the second loudspeaker arrangement; the second signal processing module being configured to process the second electrical microphone signal and to provide the second electrical loudspeaker signal; wherein
the second loudspeaker arrangement has a principal transmitting direction into which it radiates its maximum sound energy, the second loudspeaker arrangement being disposed such that the radiated maximum sound energy is concentrated at the first passenger position.
